(19) United States
(12) Patent Application Publication
(10) Pub. No.: US 2004/0174819 A1
(43) Pub. Date: Sep. 9, 2004

(54) Physical layer (PHY) with smart cable analyzing (SCA) and apparatus employing the same

(76) Inventors: Tsu-Chun Liu, Hsinchu (TW); Chieh-Yuan Ke, Hsinchu (TW); Chung-Cheng Chen, Hsinchu (TW); Tien-Ju Tsai, Changhua (TW); Jean-Ming Lee, Hsinchu (TW); Kun-Che Chung, Chiai (TW)

Correspondence Address: WU & CHEUNG, LLP, Suite 710, 7700 IRVINE CENTER DRIVE, Irvine, CA, 92618-3043, US

(21) Appl. No.: 10/453,343

(22) Filed: Jun. 2, 2003

(30) Foreign Application Priority Data
Mar. 3, 2003 (TW) 92104357

(51) Int. Cl. H04L 12/56; H04L 12/26

(52) U.S. Cl. 370/244; 370/401

(57) ABSTRACT

A physical layer with smart cable analyzing (SCA) and the apparatus employing the same. When poor quality is possibly found in the cable connecting to the physical layer, its loop back controller is used to control the timing for entering into the loop back test mode, so as to analyze the cable quality and assist the user to exclude the root cause of the problem.

### CROSS-REFERENCE TO RELATED APPLICATION

This application claims the priority benefit of Taiwan application serial no. 92104357, filed Mar. 3, 2003.

### BACKGROUND OF THE INVENTION

1. Field of Invention

The present invention generally relates to a physical layer (PHY) and the apparatus employing the same, and more particularly, to a physical layer with smart cable analyzing (abbreviated as SCA) and the apparatus employing the same.

2. Description of Related Art

Due to the progress of the electronic techniques, computers and various information digital devices are now being gradually accepted and widely used. In order to achieve the object of sharing resources, network has become essential equipment for exchanging information. In various network equipment, due to the characteristics of having easy acquiring, convenience setup, and fast transmission rate, equipment related to Ethernet have vigorously developed, and its transmission rate has upgraded from 10 Mbps to 100 Mbps and even 1 Gbps.

In Ethernet equipment, the network nodes such as Ethernet Switch or network adapter receive the packet transmitted on the network via the physical layer that provides the network connection port, so as to achieve the object of exchanging information and sharing resources. However, when the network quality is poor, the conventional network device lacks smart analyzing capability to analyze cable quality for isolating and excluding the root cause of the error. Therefore, it causes a great inconvenience to users.

### SUMMARY OF THE INVENTION

To solve the problem mentioned above, the present invention provides a physical layer with smart cable analyzing (abbreviated as SCA) and the apparatus employing the same. It can provide its built-in loop back test mode for analyzing cable quality when the cable quality is poor, so as to clearly isolate and exclude the root cause of the error.

In order to achieve the object mentioned above and others, the present invention provides a physical layer with SCA. It is suitable for transmitting and receiving the packet, such as the Ethernet packet, and also has an access interface that connects to a Media Access Controller (abbreviated as MAC), such as one access interface among the MII/RMII/SMII/SS-SMII/GMII/RGMII/SGMII/TBI/RTBI. Certainly, the access interface also comprises a management interface such as MDC/MDIO, so that the CPU (Central Processing Unit) connected to the physical layer device employing the smart cable analyzing (SCA) function, such as the Ethernet Switch or Ethernet adapter can access its register.

The physical layer with SCA comprises a loop back controller, a transmitting multiplexer circuit, a packet transmitter, a packet receiver, a management packet discriminator, and a receiving multiplexer circuit. Wherein, the loop back controller generates a management packet and determines the timing for entering into the loop back test mode according to the instruction command it received. The transmitting multiplexer circuit couples to the loop back controller and selectively switches the packet transmitting path from the access interface to the loop back controller when the loop back controller intends to send out the management packet. The packet transmitter couples to the transmitting multiplexer circuit and drives and transmits the management packet onto the network. The packet receiver receives the management packet mentioned above from the network and transmits it to the management packet discriminator. The management packet discriminator determines whether the packet received by the packet receiver is a management packet or not. The receiving multiplexer circuit couples to the management packet discriminator and the loop back controller, and selectively switches the packet transmitting path from the access interface mentioned above to the loop back controller when the management packet discriminator determines that the packet it received is a management packet.

In a preferred embodiment of the present invention, it is assumed that the physical layer with SCA is employed in the Network Switch, when the Network Switch intends running in the loop back test mode, the switch connected to outside issues an instruction command to notify the loop back controller, and the loop back controller will generate and send out a “request starting loop back test packet”.

When the loop back controller connected to the physical layer with SCA, such as the network adapter receives this “request starting loop back test packet”, a byte value in the register is set so as to be read by the CPU of the computer where the network adapter is installed.

After the CPU reads the set byte value of the register, it recognizes that the Network Switch intends to start the loop back test, and another byte value in the register is set via the access interface. After the byte in the register is set, the loop back controller will generate and send out a “starting loop back test packet” to notify the Network Switch.

When the loop back controller of the physical layer with SCA inside the Network Switch receives the “starting loop back test packet”, it switches and enters into the loop back test mode for implementing the loop back test, and then generates and sends out a “recognized starting loop back test packet.” In the loop back test mode, the loop back controller transmits the received packet via the transmitting multiplexer circuit.

When the loop back controller of the physical layer with SCA inside the network adapter receives the “recognized starting loop back test packet”, a byte value in the register is set, so as to notify the CPU of the computer where the network adapter is installed starting to transmit the test packet.

When the test is completed and the intention is to stop, the CPU of the computer where the network adapter is installed sets the byte value of the register via the access interface connected to the physical layer with SCA. Wherein, the byte of the register being set comprises a “loop back test result bit” and a “request stopping test bit”. The loop back controller generates and sends out a “stopping loop back test packet” according to the setting value of the “request stopping test bit”. Further, the set “loop back test result bit” is transmitted accompanying with it in the “stopping loop back test packet”.

When the loop back controller of the physical layer with SCA inside the Network Switch receives the “stopping loop back test packet”, the “loop back test result bit” mentioned above is used to drive a LED display, and a “recognized stopping loop back test packet” is generated and sent out to notify the opposite party.

When the loop back controller of the physical layer with SCA inside the network adapter receives the “recognized stopping loop back test packet”, a byte value of the register is set for confirming stopping the test.

Wherein, the management packet it used is an 11 bytes non-IEEE standard format IC+ management packet.

In summary, the physical layer with SCA and the apparatus employing the same provided by the present invention can enter into the built-in loop back test mode immediately once the poor network quality is found, so as to analyze the cable quality and clearly isolate and exclude the root cause of the error. Therefore, it is very convenient to the user.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a connection diagram of a network apparatus of a preferred embodiment according to the present invention.

FIG. 2 schematically shows a block diagram of a physical layer with SCA of the preferred embodiment according to the present invention.

FIG. 3 schematically shows a format of a management packet of the preferred embodiment according to the present invention.

FIG. 4 schematically shows a conversation sequence of the starting loop back test of the preferred embodiment according to the present invention.

### DESCRIPTION OF THE PREFERRED EMBODIMENTS

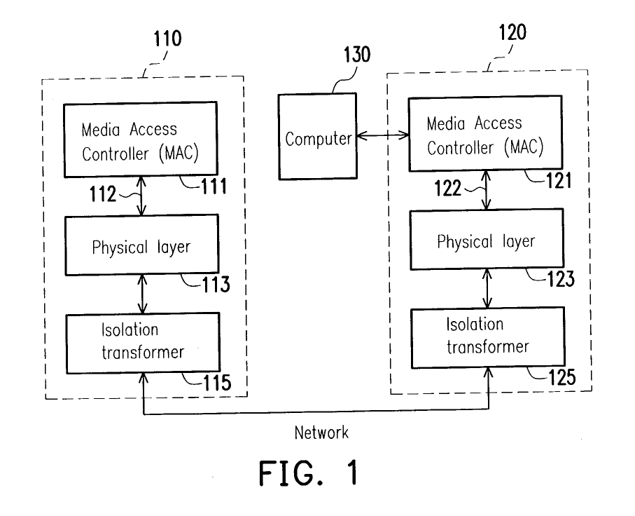

Referring to FIG. 1, it schematically shows a connection diagram of a network apparatus of a preferred embodiment according to the present invention. The network is such as Ethernet, and the CAT5 cable is used to connect an Ethernet Switch 110 and an Ethernet adapter 120. The Ethernet Switch 110 comprises a MAC 111, a physical layer with SCA 113, and an isolation transformer 115. The Ethernet adapter 120 installed on the computer 130 comprises a MAC 121, a physical layer with SCA 123, and an isolation transformer 125.

Wherein, the Ethernet Switch 110 switches the packets transmitted on the network. The Ethernet adapter 120 transmits the packet that is intended to be transmitted by the computer 130 to the network, and receives the packet intended to be transmitted from the network to the computer 130. The isolation transformer 115 and 125 are used to isolate noises on the network. The CPU (not shown) inside the computer 130 is used to send and receive the packet. Further, the MAC 111 and 112 couples to the physical layer with SCA 113 and 123 via the access interface 112 and 122, respectively. Wherein, the access interface 112 and 122 is one access interface among the interfaces of the MII/RMII/SMII/SS-SMII/GMII/RGMII/SGMII/TBI/RTBI. Certainly, the access interface 112 and 122 also comprise a management interface such as MDC/MDIO, so that the CPU can access its register via the MDC/MDIO.

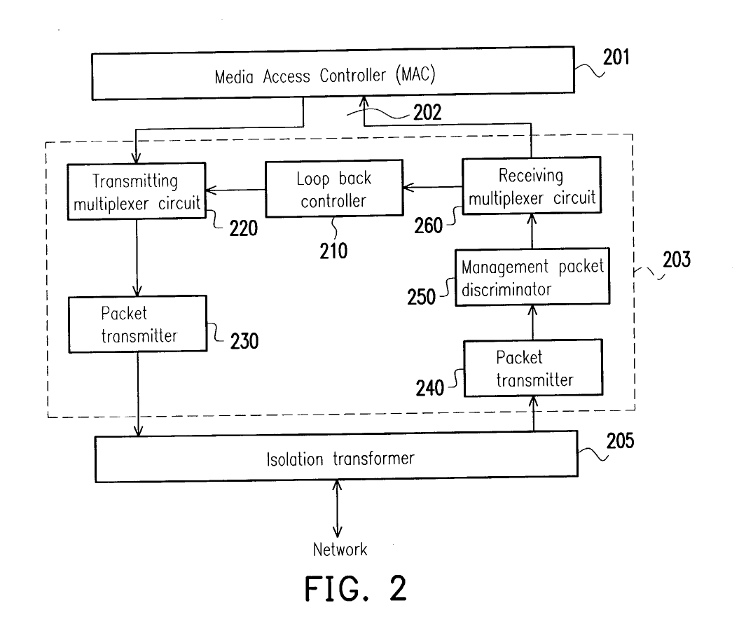

Referring to FIG. 2, it schematically shows a block diagram of a physical layer with SCA of the preferred embodiment according to the present invention. As shown in the diagram, the physical layer with SCA 203 couples to a MAC 201 via an access interface 202, and an isolation transformer 205 is used to isolate noises on the network. Wherein, the MAC 201 may be either the MAC 111 or 121 shown in FIG. 1, and the isolation transformer 205 may be either the isolation transformer 115 or 125 shown in FIG. 1.

As shown in the diagram, the physical layer with SCA 203 comprises a loop back controller 210, a transmitting multiplexer circuit 220, a packet transmitter 230, a packet receiver 240, a management packet discriminator 250, and a receiving multiplexer circuit 260. The loop back controller 210 couples to the transmitting multiplexer circuit 220 and the receiving multiplexer circuit 260, the packet transmitter 230 couples to the transmitting multiplexer circuit 220, and the management packet discriminator 250 couples to the packet receiver 240 and the receiving multiplexer circuit 260.

Wherein, the loop back controller 210 generates a management packet and determines the timing for entering into the loop back test mode according to the instruction command it received. The transmitting multiplexer circuit 220 selectively switches the packet transmitting path from the access interface 202 to the loop back controller 210 when the loop back controller 210 intends to send out the management packet. The packet transmitter 230 drives and transmits the management packet onto the network. The packet receiver 230 receives the management packet from the network, and transmits it to the management packet discriminator 250. The management packet discriminator 250 determines whether the packet received from the packet receiver 240 is a management packet or not; if it is, then the packet transmitting path is selectively switched from the access interface 202 to the loop back controller 210.

In order to have the Ethernet Switch 110 or the Ethernet adapter 120 of FIG. 1 actively start its built-in loop back test function when poor quality of network cable is possibly found so as to analyze the network cable quality, inside the physical layer with SCA 203, there are some registers that can be set up by the CPU, so as to issue the instruction command and display the status of the physical layer with SCA 203. The registers (not shown) are as follows:

Register B:

Bit 0: set up as “1” to instruct issuing a “starting loop back test command”

Bit 1: set up as “1” to indicate the “starting loop back test command” has been issued

Bit 2: set up as “1” to instruct issuing a “stopping loop back test command”

Bit 3: set up as “1” to indicate the “stopping loop back test command” has been issued

Bit 4: set up as “1” to indicate the test result is good, “0” to indicate the test result is poor

Bit 5: set up as “1” to instruct issuing a “request starting loop back test command”

Bit 6˜7: Reserved

Register C:

Bit 0: set up as “1” to indicate the “request starting loop back test command” has been received

Bit 1: set up as “1” to indicate the “recognized starting loop back test command” has been received

Bit 2: set up as “1” to indicate the “recognized stopping loop back test command” has been received

Bit 3˜7: Reserved

All bytes value of the register mentioned above can be automatically cleared after it is read.

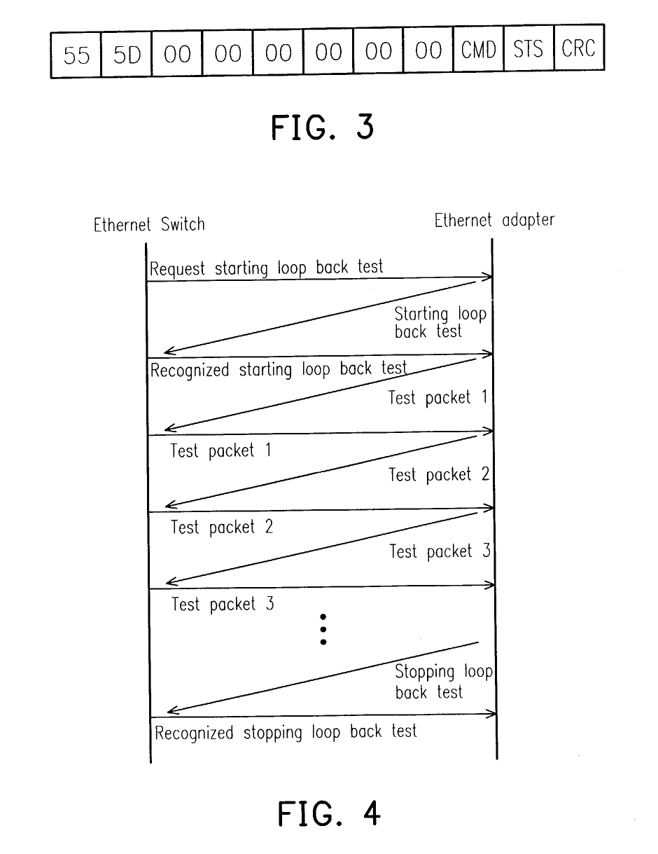

When the register value has been set by the CPU so as to instruct the physical layer with SCA 203 to issue the instruction command, the physical layer with SCA 203 generates and sends out a 11 bytes non-IEEE standard format IC+ management packet to reply to it. As shown in FIG. 3, the format of the management packet has 11 bytes, wherein the first byte “55” is a preamble byte, the second byte “5D” is a start frame delimiter (STD), the 3^{rd}˜8^{th} bytes are the empty bytes with value of “00”, the 9^{th} byte is a command byte CMD, and they are distributed as follows in the present embodiment:

Bit 0: Reserved

Bit 1: set up as “1” to indicate the “request starting loop back test command”

Bit 2: set up as “1” to indicate the “recognized stopping loop back test command”

Bit 3: set up as “1” to indicate the “stopping loop back test command”

Bit 4: set up as “1” to indicate the “recognized starting loop back test command”

Bit 5: set up as “1” to indicate the “starting loop back test command”

Bit 6˜7: Reserved

The 10^{th} byte STS is a status byte, in the present embodiment, “1” in the bit 0 indicates that the test result showing the cable quality is good, while “0” in the bit 0 indicates that the test result showing the cable has a poor quality, and all other bits are reserved and not used. The 11^{th} byte is a CRC (Cyclic Redundancy Check) code. For easy understanding, FIG. 1 and FIG. 2, the register and the management packet mentioned above are referred to hereinafter for explaining the loop back test function of the physical layer with SCA 203.

At first, it is assumed that the Ethernet Switch 110 will start the loop back test, meanwhile, the bit 5 of the register B can be set by the switch connects to outside or the processor of the Ethernet Switch 110 to issue an instruction command. After the loop back controller 210 of the physical layer 113 receives the instruction command, it generates and sends out a “request starting loop back test packet” that includes the “request starting loop back test command”, i.e. the management packet whose bit 1 of the 9^{th} byte CMD is set as “1”.

The “request starting loop back test packet” is transmitted to the Ethernet adapter 120 via the network. When the loop back controller 210 of the physical layer 123 inside the Ethernet adapter 120 receives the “request starting loop back test packet”, the bit 0 of the register C is set. Meanwhile, it can be set to issue a CPU interrupt request, or the CPU can be set for polling the register value.

When the register C is read by the CPU of the computer 130, it is known that the Ethernet Switch 110 intends to start the loop back test, the bit 0 of the register B can be set via the access interface 122. When the bit 0 of register B has been set, the loop back controller 210 of the Ethernet adapter 120 generates and sends out a “starting loop back test packet” that includes the “starting loop back test command”, i.e., the management packet whose bit 5 of the 9^{th} byte CMD is set as “1”, so as to notify the Ethernet Switch 110 and set the bit 1 of the register B for reading by the CPU. Certainly, if the Ethernet adapter 120 intends to start the loop back test, optionally, it can be achieved by setting the bit 0 of the register B.

When the loop back controller 210 of the physical layer 113 inside the Ethernet Switch 110 receives the “starting loop back test packet”, it switches and enters into the loop back test mode that implements the loop back test, and also generates and sends out a “recognized starting loop back test packet” that includes the “recognized starting loop back test command”, i.e. the management packet whose bit 4 of the 9^{th} byte CMD is set as “1”.

When the loop back controller 210 of the physical layer 123 inside the Ethernet adapter 120 receives the “recognized starting loop back test packet”, the bit 1 of the register C is set. Similarly, it can be set to issue a CPU interrupt request, or the CPU can be set for polling the register value.

When the register C has been read by the CPU of the computer 130, the test packet is start to transmit for performing the test. Meanwhile, since the loop back controller 210 of the physical layer 113 inside the Ethernet Switch 110 has entered into the loop back test mode, it receives the packet from the network and transmits it to the Ethernet adapter 120. The computer 130 then calculates and generates the loop back test result that indicates whether the cable quality is good or not, and the loop back test result is subsequently written into the bit 4 of the register B.

When the test is completed and it is intended to stop the loop back test, the CPU of the computer 130 sets the bit 2 of the register B via the access interface 122. The loop back controller 210 of the physical layer 123 generates and sends out a “stopping loop back test packet” that includes the “stopping loop back test command”, i.e., the management packet whose bit 3 of the 9^{th} byte CMD is set as “1”. The bit 0 of the 10^{th} byte STS in the “stopping loop back test packet” indicates the loop back test result.

When the loop back controller 210 of the physical layer 113 inside the Ethernet Switch 110 receives the “stopping loop back test packet”, the bit 0 of the 10^{th} byte STS is referred to drive the LED, so as to display the loop back test result and save the loop back test result into a register. Then, a “recognized stopping loop back test packet” that includes the “recognized stopping loop back test command”, i.e. the management packet whose bit 2 of the 9^{th} byte CMD is set as “1” is generated and sent out to notify the opposite party.

When the loop back controller 210 of the physical layer 123 inside the Ethernet adapter 120 receives the “recognized stopping loop back test packet”, the bit 2 of the register C is set, so that the computer 130 can confirms it and stops the test.

Reference to the conversation sequence as shown in FIG. 4 indicates its operation principle. Certainly, even FIG. 4 shows an example that the loop back test is actively started by the Ethernet Switch, if it is intended to have the Ethernet adapter actively start the loop back test, the Ethernet adapter can actively start the “starting loop back test command” without having to wait for the “request starting loop back test command” as shown in the diagram. The subsequent processes are the same the ones shown in FIG. 4.

In summary, the present invention at least has following advantages:

1. It can start its built-in loop back test function immediately to analyze cable quality when the poor network quality is found.

2. It can clearly isolate and exclude the root cause of the error, so as to facilitate the user's usage.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A physical layer with smart cable analyzing (SCA), suitable for transmitting and receiving a packet on a network, and has an access interface that connects to a Media Access Controller (MAC), comprising:
a loop back controller, used to generate a management packet and determine timing for entering into a loop back test mode according to an instruction command;
a transmitting multiplexer circuit, coupled to the loop back controller, used to selectively switch a packet transmitting path from the access interface to the loop back controller when the loop back controller intends to send out the management packet;
a packet transmitter, coupled to the transmitting multiplexer circuit, used to drive and transmit the management packet onto the network;
a packet receiver, used to receive the management packet from the network;
a management packet discriminator, coupled to the packet receiver, used to determine whether the packet received from the packet receiver is the management packet or not; and
a receiving multiplexer circuit, coupled to the management packet discriminator and the loop back controller, used to selectively switch a packet transmitting path from the access interface to the loop back controller when the management packet discriminator determines the received packet is the management packet.

2. A physical layer with SCA of claim 1, wherein when it is intended to start the loop back test, the instruction command can be issued via turning on a switch, and the loop back controller uses a “request starting loop back test packet” to reply to it.

3. A physical layer with SCA of claim 2, wherein when the loop back controller receives the “request starting loop back test packet”, a byte value of a register is set.

4. A physical layer with SCA of claim 1, wherein when it is intended to start the loop back test, a byte value of the register is set via the access interface, and the loop back controller uses a “starting loop back test packet” to reply to it.

5. A physical layer with SCA of claim 4, wherein when the loop back controller receives the “starting loop back test packet”, it switches and enters into the loop back test mode and uses a “recognized starting loop back test packet” to reply it.

6. A physical layer with SCA of claim 5, wherein when the loop back controller receives the “recognized starting loop back test packet”, a byte of the register is set.

7. A physical layer with SCA of claim 1, wherein when it is intended to stop the loop back test, a byte of the register is set via the access interface, and the loop back controller uses a “stopping loop back test packet” to reply to it.

8. A physical layer with SCA of claim 7, wherein when the loop back controller receives the “stopping loop back test packet”, a “recognized stopping loop back test packet” is used to reply to it.

9. A physical layer with SCA of claim 8, wherein when the loop back controller receives the “recognized stopping loop back test packet”, a byte value of the register is set.

10. A physical layer with SCA of claim 7, wherein the “stopping loop back test packet” comprises a “loop back test result bit”, and the loop back controller uses the “loop back test result bit” to drive a LED display.

11. A physical layer with SCA of claim 1, wherein the management packet is an 11 bytes non-IEEE standard format packet.

12. A physical layer with SCA of claim 1, wherein the network is an Ethernet.

13. A physical layer with SCA of claim 1, wherein the access interface is one of the MII/RMII/SMII/SS-SMII/GMII/RGMII/SGMII/TBI/RTBI.

14. A network apparatus, suitable for transmitting and receiving a packet on a network, comprising:
a physical layer, used to transmit and receive the packet on the network and generate a management packet according to an instruction command, and also used to determine whether the received packet is the management packet or not, if the management packet is received, the timing for entering into the loop back test mode is determined and replied according to the management packet;
a MAC, coupled to the physical layer via an access interface, used to process and transmit the received packet; and
an isolation transformer, coupled to the physical layer, used to isolate noises on the network.

15. The network apparatus of claim 14, wherein when it is intended to start the loop back test, the instruction command can be issued via turning on a switch, and the physical layer uses a “request starting loop back test packet” to reply to it.

16. The network apparatus of claim 15, wherein when the physical layer receives the “request starting loop back test packet”, a byte value of a register is set.

17. The network apparatus of claim 14, wherein when it is intended to start the loop back test, a byte value of the register is set via the access interface, and the physical layer uses a “starting loop back test packet” to reply to it.

18. The network apparatus of claim 17, wherein when the physical layer receives the “starting loop back test packet”, it switches and enters into the loop back test mode and uses a “recognized starting loop back test packet” to reply to it.

19. The network apparatus of claim 18, wherein when the physical layer receives the “recognized starting loop back test packet”, a byte of the register is set.

20. The network apparatus of claim 14, wherein when it is intended to stop the loop back test, a byte of the register is set via the access interface, and the physical layer uses a “stopping loop back test packet” to reply to it.

21. The network apparatus of claim 20, wherein when the physical layer receives the “stopping loop back test packet”, a “recognized stopping loop back test packet” is used to reply to it.

22. The network apparatus of claim 21, wherein when the physical layer receives the “recognized stopping loop back test packet”, a byte value of the register is set.

23. The network apparatus of claim 20, wherein the “stopping loop back test packet” comprises a “loop back test result bit”, and the physical layer uses the “loop back test result bit” to drive a LED display.

24. The network apparatus of claim 14, wherein the management packet is an 11 bytes non-IEEE standard format packet.

25. The network apparatus of claim 14, wherein the network is an Ethernet, and the network apparatus is an Ethernet Switch.

26. The network apparatus of claim 14, wherein the network is an Ethernet, and the network apparatus is an Ethernet adapter.

27. The network apparatus of claim 14, wherein the access interface is one of the MII/RMII/SMII/SS-SMII/GMII/RGMII/SGMII/TBI/RTBI.
